(19) United States
(12) Patent Application Publication
(10) Pub. No.: US 2009/0041412 A1
(43) Pub. Date: Feb. 12, 2009

(54) Laser erosion processes for fiber optic ferrules

(76) Inventors: Jeffrey Dean Danley, Hickory, NC (US); James Phillip Luther, Hickory, NC (US); Dennis Michael Knecht, Hickroy, NC (US); Joel Christopher Rosson, Hickory, NC (US)

Correspondence Address: CORNING INCORPORATED, INTELLECTUAL PROPERTY DEPARTMENT, SP-TI-3-1, CORNING, NY, 14831, US

(21) Appl. No.: 11/890,676

(22) Filed: Aug. 7, 2007

(51) Int. Cl. G02B 6/36; B29D 11/00

(52) U.S. Cl. 385/85; 216/24

(57) ABSTRACT

A method for processing fiber optic ferrules, the method comprising: providing a fiber optic ferrule defining an endface portion and a pedestal portion about one or more protruding optical fibers; mechanically polishing the one or more protruding optical fibers substantially flush with the pedestal portion; and non-mechanically eroding the pedestal portion about the one or more protruding optical fibers to a depth of at least the end face portion such that the one or more optical fibers remain protruding from the endface portion. Non-mechanically eroding may include laser erosion or chemical erosion.

### BACKGROUND OF THE INVENTION

1. Field of the Invention

The present invention relates generally to the processing of fiber optic ferrules, and more specifically, to erosion processes for removing ferrule material from the ferrule end face about the optical fibers so that the fibers protrude a predetermined distance from the end face.

2. Technical Background of the Invention

Conventional mechanical processes for shaping and preparing the end face of fiber optic ferrules, and providing for the selection of the associated optical fiber protrusion lengths, typically involve inserting and bonding the optical fibers in the fiber optic ferrule such that they have a protrusion length that exceeds a desired final protrusion length, for example, and then cleaving or polishing the optical fibers to the desired protrusion length, with minimal polishing of the endface of the fiber optic ferrule. Most often, these mechanical processes result in the optical fibers being polished flush with the endface of the fiber optic ferrule. This is disadvantageous as it is often desirable to provide at least 1-5 μm of optical fiber protrusion in order to account for temperature and humidity variations. Metrological properties are then examined in order to determine coplanarity, protrusion length, and optical fiber angle, among other properties.

What is needed in the art are mechanical processing techniques for treating fiber optic ferrules that involve minimal optical fiber tip modification, these mechanical processes providing for the precise selection of the associated optical fiber protrusion lengths. As such processes may render the end face of the fiber optic ferrule unsuitable for interferometric measurements due to the very rough, non-reflective surface that results, it is also desirable to provide suitable metrology reference surfaces that can be measured against the protruding fiber optic ferrules to determine fiber height and coplanarity.

### BRIEF SUMMARY OF THE INVENTION

In various embodiments, the present invention provides laser erosion processes for shaping and preparing the end face of a fiber optic ferrule that involve minimal optical fiber tip modification. The laser erosion processes provide for the precise selection of the associated optical fiber protrusion length. As such laser erosion processes typically render the endface of the fiber optic ferrule unsuitable for interferometric measurements due to the very rough, non-reflective surface that results, integral datums may be positioned about the ferrule end face to provide a suitable metrology reference surface. One form of integral datum may include a reference surface recessed within one or more guide pin bores. In embodiments in which laser erosion processes result in core erosion of the optical fibers, masking, the use of oblique laser beam irradiation angles, and/or a clean-up flocking may be included as processing steps. Masking and the use of oblique laser beam irradiation angles eliminate direct laser beam interaction with the optical fiber core. A clean-up flocking step combines the laser erosion processes of the present invention with conventional mechanical processes for shaping and preparing the endfaces of fiber optic ferrules, remedying the preferential core erosion of the optical fibers after the fact.

In one embodiment, the present invention provides an erosion process for shaping and preparing an endface of a fiber optic ferrule that involves minimal optical fiber tip modification, the erosion process providing for the precise selection of the associated optical fiber protrusion length. The process includes mechanically polishing one or more optical fibers flush with a surface of a pedestal structure disposed on a surface of an end face of a fiber optic ferrule, wherein the one or more optical fibers and the pedestal structure have an initial height above the surface of the endface of the fiber optic ferrule that is approximately equal to a desired final protrusion height of the one or more optical fibers above the surface of the endface of the fiber optic ferrule; and non-mechanically eroding the pedestal structure disposed on the surface of the endface of the fiber optic ferrule from around the one or more optical fibers. Optionally, the non-mechanically eroding step consists of eroding the pedestal structure disposed on the surface of the endface of the fiber optic ferrule from around the one or more optical fibers using a laser. Optionally, the erosion process also includes masking the one or more optical fibers prior to eroding the pedestal structure disposed on the surface of the endface of the fiber optic ferrule from around the one or more optical fibers. Optionally, the non-mechanically eroding step consists of eroding the pedestal structure disposed on the surface of the endface of the fiber optic ferrule from around the one or more optical fibers using a chemical. Preferably, the pedestal structure disposed on the surface of the endface of the fiber optic ferrule is integrally formed with the surface of the endface of the fiber optic ferrule. Preferably, the surface of the endface of the fiber optic ferrule comprises one or more integral datums. In this embodiment, the erosion process further includes mechanically flocking the endface of the fiber optic ferrule.

In another embodiment, the present invention provides a laser erosion process for shaping and preparing an endface of a fiber optic ferrule that involves minimal optical fiber tip modification, this laser erosion process providing for the precise selection of the associated optical fiber protrusion lengths and the incorporation of integral datums, the laser erosion process including: mechanically polishing one or more optical fibers flush with a surface of a pedestal structure disposed on a surface of an endface of a fiber optic ferrule, wherein the one or more optical fibers and the pedestal structure have an initial height above the surface of the endface of the fiber optic ferrule that is approximately equal to a desired final protrusion height of the one or more optical fibers above the surface of the endface of the fiber optic ferrule; and laser eroding the pedestal structure disposed on the surface of the endface of the fiber optic ferrule from around the one or more optical fibers. Optionally, the laser erosion process also includes masking the one or more optical fibers prior to eroding the pedestal structure disposed on the surface of the endface of the fiber optic ferrule from around the one or more optical fibers. Preferably, the pedestal structure disposed on the surface of the endface of the fiber optic ferrule is integrally formed with the surface of the endface of the fiber optic ferrule. Preferably, the surface of the endface of the fiber optic ferrule comprises one or more integral datums. Optionally, the laser erosion process further includes mechanically flocking the endface of the fiber optic ferrule.

In a further embodiment, the present invention provides a fiber optic ferrule formed by an erosion process for shaping and preparing an endface of the fiber optic ferrule that involves minimal optical fiber tip modification, this erosion process providing for the precise selection of the associated optical fiber protrusion lengths and the incorporation of integral datums, the erosion process including: mechanically polishing one or more optical fibers flush with a surface of a pedestal structure disposed on a surface of an endface of the fiber optic ferrule, wherein the one or more optical fibers and the pedestal structure have an initial height above the surface of the endface of the fiber optic ferrule that is approximately equal to a desired final protrusion height of the one or more optical fibers above the surface of the endface of the fiber optic ferrule; and non-mechanically eroding the pedestal structure disposed on the surface of the endface of the fiber optic ferrule from around the one or more optical fibers. Optionally, the non-mechanically eroding step of the erosion process consists of eroding the pedestal structure disposed on the surface of the endface of the fiber optic ferrule from around the one or more optical fibers using a laser. Optionally, the erosion process also includes masking the one or more optical fibers prior to eroding the pedestal structure disposed on the surface of the endface of the fiber optic ferrule from around the one or more optical fibers. Optionally, the non-mechanically eroding step of the erosion process consists of eroding the pedestal structure disposed on the surface of the endface of the fiber optic ferrule from around the one or more optical fibers using a chemical. Preferably, the pedestal structure disposed on the surface of the endface of the fiber optic ferrule is integrally formed with the surface of the endface of the fiber optic ferrule. Preferably, the surface of the endface of the fiber optic ferrule comprises one or more integral datums. Optionally, the erosion process further includes mechanically flocking the endface of the fiber optic ferrule.

It is to be understood that both the foregoing general description and the following detailed description provide exemplary embodiments of the present invention, and an overview or framework for understanding the nature and character of the present invention as it is claimed. The accompanying drawings are included in order to provide a further understanding of the present invention, and are incorporated into and constitute a part of this specification. The accompanying drawings illustrate the various exemplary embodiments of the present invention and, together with the detailed description, serve to explain the principles of operation thereof. The accompanying drawings are meant to be illustrative, and not limiting.

### BRIEF DESCRIPTION OF THE DRAWINGS

The present invention is illustrated and described herein with reference to the various drawings, in which like reference numbers are used to denote like process steps and/or assembly components, as appropriate.

FIG. 1 is a perspective view of a multi-fiber ferrule including a pedestal positioned about the optical fibers prior to the pedestal being removed in accordance with processes of the present invention.

FIG. 2 is a perspective view of the multi-fiber ferrule of FIG. 1 shown with the pedestal portion removed in accordance with processes of the present invention.

### DETAILED DESCRIPTION OF THE INVENTION

In various embodiments, the present invention provides laser erosion processes for treating the endface of a fiber optic ferrules that involve minimal optical fiber tip modification, the laser erosion processes providing for the precise selection of the associated optical fiber protrusion lengths and optionally the incorporation of integral datums. As such laser erosion processes typically render the endface of the fiber optic ferrule unsuitable for interferometric measurements due to the very rough, non-reflective surface that results, integral datums may be formed to provide suitable metrology reference surfaces. One form of an integral datum includes a reference surface recessed within the guide pin bores. As such laser erosion processes also typically result in preferential core erosion of the optical fibers, masking, the use of oblique laser beam irradiation angles, and/or a clean-up flocking step are preferred. Masking and the use of oblique laser beam irradiation angles eliminate direct laser beam interaction with the optical fiber core. A clean-up flocking step combines the laser erosion processes of the present invention with conventional mechanical processes for shaping and preparing the endfaces of fiber optic ferrules, remedying the preferential core erosion of the optical fibers after the fact.

The laser processing methods include using a relatively high laser power to ablate small fiber optic ferrule filler particles (these particles consisting of glass, for example) and incorporating a post polish step to remove endface texturing and contamination. The process includes inserting and bonding one or more optical fibers in a fiber optic ferrule, followed by rough polishing the one or more optical fibers and any excess epoxy used in the bonding step. The rough polishing step is accomplished by mechanical means using a coarse grain film (about 3-5 μm film), for example. Next, the process includes polishing the optical fibers and the endface of the fiber optic ferrule by mechanical means using a fine grain film (about 0.5-1 μm film), for example. Next, the process includes fine polishing the optical fibers and the endface of the fiber optic ferrule by mechanical means using a fine grain film (about 0.5 μm film), for example.

Subsequently, the process includes laser treating a portion of the endface of the fiber optic ferrule in order to selectively remove material surrounding the optical fibers. Specifically, the laser treatment involves the application of a CO2 or Nd-Yag laser, for example, or the like at an angle of between about 0 degrees (head-on) and about 45 degrees for a time period of about 5 pulses. The pulse width is between about 0.0001 and about 0.001 seconds, for example, and the laser power in continuous mode is between about 40 and about 100 watts. In pulse mode, the energy is between about 4 and about 100 mJ per pulse. The process then again includes polishing or flocking the optical fibers and the endface of the fiber optic ferrule by mechanical means using a flocking material.

Another laser processing method includes using a relatively low laser power to slough off substantially all fiber optic ferrule filler particles (these particles consisting of glass, for example) and incorporating an optional post polish step for clean up. In this embodiment, the size of the fiber optic ferrule filler particles is of particular importance, as there are often issues cleaning optical fibers greater than about 20 μm in length. Thus, the size of the fiber optic ferrule filler particles should be smaller than about 20 μm.

Specifically, the process includes inserting and bonding one or more optical fibers in a fiber optic ferrule followed by rough polishing the one or more optical fibers and any excess epoxy used in the bonding step. As in the previous method, rough polishing is accomplished by mechanical means using a coarse grain film (about 3-5 μm), for example. Next, the process includes polishing the optical fibers and the endface of the fiber optic ferrule by mechanical means using a fine grain film (about 0.5-1 μm), for example. Next, the process includes fine polishing the optical fibers and the endface of the fiber optic ferrule by mechanical means using a fine grain film (about 0.5 μm), for example.

Subsequently, the process includes laser treating the endface of the fiber optic ferrule in order to selectively remove the material surrounding the optical fibers. Specifically, this laser treatment involves the application of a CO2 or Nd-Yag laser or the like at an angle of about 0 degrees (head-on) for a time period of about 10 pulses. The pulse width is about 0.001 seconds, for example, and the laser power in continuous mode is between about 4 and about 30 watts. In pulse mode, the energy is between about 5 and about 30 mJ per pulse. The process includes again polishing or flocking the optical fibers and the endface of the fiber optic ferrule by mechanical means using a flocking material.

As described above, the optical fibers may be masked during laser treatment by disposing a material that is transparent to laser energy between the laser source and the endface of the ferrule in regions that are desired to be laser treated and opaque to laser energy between the laser source and the optical fibers in regions that are not desired to be laser treated. Suitable masking materials and configurations include, but are not limited to, a ZnSe window for a CO2 laser and a quartz window for a Nd-Yag laser. In general, any reflective or absorbent material, such as copper, etc., can be deposited on the surface of the window in order to mask the optical fibers.

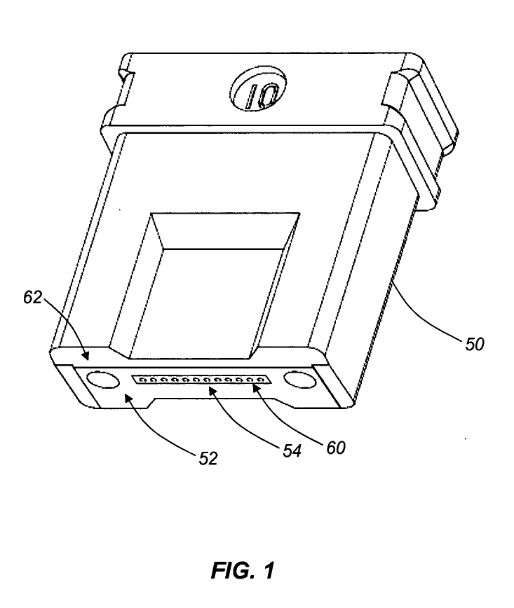

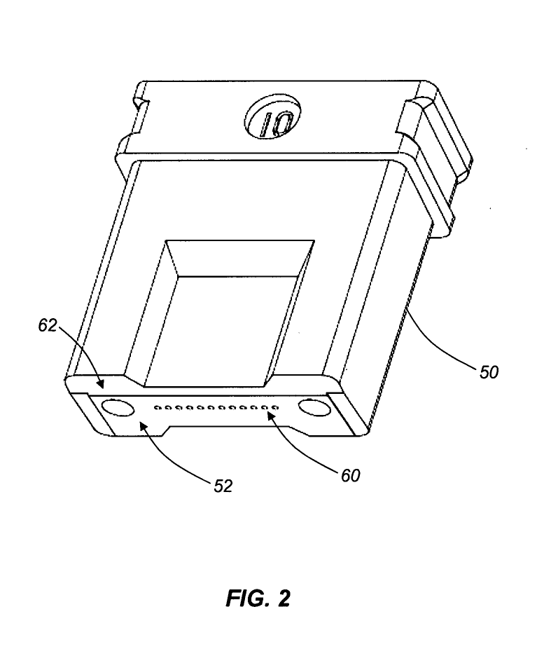

Referring to FIGS. 1 and 2, in either of the above-referenced embodiments, the endface 52 of the fiber optic ferrule 50 may be initially (mechanically) polished such that a pedestal 54 is first formed in the area immediately surrounding the one or more optical fibers 60 (see FIG. 1), with the height of the pedestal 54 being substantially equal to the desired protrusion height of the one or more optical fibers 60 above the remainder of the endface 52 of the fiber optic ferrule 50 that is not treated with the laser. For example, the height of the pedestal 54 may be about 10-15 μm, which is substantially equal to or slightly greater than the final desired protrusion height of the one or more optical fibers 60 above the remainder of the endface 52 of the fiber optic ferrule 50. The pedestal 54 is then laser treated, via a substantially frontal illumination process, and removed to at least the depth of the remainder of the endface (see FIG. 2), and the one or more optical fibers 60 and the endface 52 of the fiber optic ferrule 50 are again polished or flocked to achieve the desired endface characteristics, if necessary.

An attractive alternative given conventional interferometer camera limitations is to use and erode only a relatively long, thin pedestal 54, providing relatively large integral datum surfaces above and below the pedestal 54, obviating the need for a larger interferometer camera or a stitching methodology. Another alternative is to provide relatively large integral datum surfaces around or recessed from the guide pin bores 62 associated with the fiber optic ferrule 50. In preferred embodiments, the integral reference surface is not altered subsequent to molding and during the lifetime of the ferrule.

Although the present invention has been illustrated and described herein with reference to preferred embodiments and specific examples thereof, it will be readily apparent to those of ordinary skill in the art that other embodiments and examples may perform similar functions and/or achieve like results. For example, although primarily laser erosion processes for fiber optic ferrules have been illustrated and described herein, the laser ablation techniques described above could be replaced with chemical etch techniques, such as a buffered HF etch or the like. This would attack the pure fused silica preferential to the epoxy. The relative size of the fibers would provide for relief relative to the filler of the ferrule as the etch progresses. The resulting ferrule would be “spongy” as the filler comprises about 80% of the ferrule volume. Surface tension would presumably hold the deposited acid to the pedestal, providing for metrology surface maintenance and the desired fiber protrusion. All such equivalent embodiments and examples are within the spirit and scope of the present invention, are contemplated thereby, and are intended to be covered by the following claims.

What is claimed is:

1. A method for processing fiber optic ferrules, comprising:
providing a fiber optic ferrule defining an endface portion and a pedestal portion about one or more protruding optical fibers;
mechanically polishing the one or more protruding optical fibers substantially flush with the pedestal portion; and
non-mechanically eroding the pedestal portion about the one or more protruding optical fibers to a depth of at least the end face portion such that the one or more optical fibers remain protruding from the endface portion.

2. The method of claim 1, further comprising polishing the one or more protruding optical fibers.

3. The method of claim 1, wherein the non-mechanically eroding step comprises eroding the pedestal portion using a laser.

4. The method of claim 3, wherein laser power is from 10 watts to 20 watts.

5. The method of claim 3, wherein laser power is from 40 watts to 100 watts.

6. The method of claim 3, wherein the laser emits a beam perpendicular to the surface of the endface of the ferrule.

7. The method of claim 3, wherein the laser emits a beam at an angle between 0 degrees and 45 degrees relative to the surface of the endface of the ferrule.

8. The method of claim 3, further comprising masking the one or more protruding optical fibers prior to eroding the pedestal portion.

9. The method of claim 1, wherein the non-mechanically eroding step comprises eroding the pedestal portion using a chemical.

10. The method of claim 1, wherein the ferrule defines at least one integral datum defining a reference surface for metrology measurements.

11. A laser erosion process for shaping and preparing an endface of a fiber optic ferrule that involves minimal optical fiber tip modification, the laser erosion process providing for the precise selection of the associated optical fiber protrusion lengths, the laser erosion process comprising:
mechanically polishing one or more optical fibers substantially flush with a surface of a pedestal structure disposed on a surface of an endface of a fiber optic ferrule, wherein the one or more optical fibers and the pedestal structure have an initial height above the surface of the endface of the fiber optic ferrule that is approximately equal to or greater than a desired final protrusion height of the one or more optical fibers above the surface of the endface of the fiber optic ferrule; and
laser eroding the pedestal structure disposed on the surface of the endface of the fiber optic ferrule from around the one or more optical fibers.

12. The laser erosion process of claim 11, wherein a laser used for the laser eroding step has a power from 10 watts to 20 watts.

13. The laser erosion process of claim 11, wherein a laser used for the laser eroding step has a power of from 40 watts to 100 watts.

14. The laser erosion process of claim 11, wherein a laser used for the laser eroding step emits a beam perpendicular to the surface of the endface of the fiber optic ferrule.

15. The laser erosion process of claim 11, wherein a laser used for the laser eroding step emits a beam at an angle from 0 degrees to 45 degrees relative to the surface of the endface of the fiber optic ferrule.

16. The laser erosion process of claim 11, further comprising masking the one or more optical fibers prior to eroding the pedestal structure disposed on the surface of the endface of the fiber optic ferrule from around the one or more optical fibers.

17. The laser erosion process of claim 11, wherein the pedestal structure disposed on the surface of the endface of the fiber optic ferrule is integrally formed with the surface of the endface of the fiber optic ferrule.

18. The laser erosion process of claim 11, wherein the fiber optic ferrule defines one or more integral datums.

19. The laser erosion process of claim 11, further comprising mechanically flocking the endface of the fiber optic ferrule.

20. A fiber optic ferrule formed by an erosion process for shaping and preparing an endface of the fiber optic ferrule that involves minimal optical fiber tip modification, this erosion process providing for the precise selection of the associated optical fiber protrusion lengths, the erosion process comprising:
mechanically polishing one or more optical fibers substantially flush with a surface of a pedestal structure disposed on a surface of an endface of the fiber optic ferrule, wherein the one or more optical fibers and the pedestal structure have an initial height above the surface of the endface of the fiber optic ferrule that is approximately equal to or greater than a desired final protrusion height of the one or more optical fibers above the surface of the endface of the fiber optic ferrule; and
non-mechanically eroding the pedestal structure disposed on the surface of the endface of the fiber optic ferrule from around the one or more optical fibers.
